(19) United States
(12) Patent Application Publication
(10) Pub. No.: US 2009/0113792 A1
(43) Pub. Date: May 7, 2009

(54) Plant Protection Method and Use

(76) Inventor: Amir Amirjazil, Potomac, MD (US)

Correspondence Address: Amir Amirjazil, 10513 Democracy Blvd., Potomac, MD, 20854, US

(21) Appl. No.: 12/135,586

(22) Filed: Aug. 19, 2008

Related U.S. Application Data
(60) Provisional application No. 60/942,662, filed on Jun. 8, 2007.

(51) Int. Cl. A01G 13/02

(52) U.S. Cl. 47/23.1; 47/32.3; 47/20.1

(57) ABSTRACT

A method for protecting trees or plants from consumption or damage by animals constitutes the use of sharp and physically agitating material over the trees or plants. In one example of the invention a sharp object like barbed wire is used to wrap around the plant where it is vulnerable.

### PRIORITY CLAIMED

The present patent application claims priority from U.S. Provisional Patent Application No. 60/942,662 filed on Jun. 8, 2007.

### FIELD OF THE INVENTION

The present invention relates to the protection of trees and plants from consumption by wild animals, and in particular, the use of sharp agitating objects to protect trees and plans.

### BACKGROUND OF THE INVENTION

Most young trees in many parts of the world are subject to the risk of consumption by wild animals before they reach a certain size. In particular, in many parts of the United States, deer population is constantly in search of young trees and other plants for consumption. This problem is made more sever by overpopulation of the deer who don't have natural enemies. As such, these wild animals are drawn to the backyards and housing areas in search of easy and consumable food, namely, young trees and other plants being planted and grown by the owners.

There are some existing products that are mostly based on scents to drive away the deer and other plant eating animals. One big problem with such application is that the scent is subject to weakening overtime. Moreover, the weakening of the scent is accelerated with rain and showers as it is washed off the plant. Yet another problem with this solution is that wild animals could learn to tolerate the scent in which case it becomes completely ineffective. Moreover, some scent releasing solutions normally constitute harsh chemicals and have negative environmental impact, and in particular, could be harmful to the tree or the plant itself.

As such, there is need for a novel solution for the protection from young trees and other plants from the consumption by wild animals.

### SUMMARY OF THE INVENTION

In one aspect, the present invention provides a method for protecting trees and plants against consumption by animals, said comprising placing an object having sharp segments on the trees and plants.

In another aspect, the present invention presents the use of sharp objects to protect trees and plants.

In yet another aspect, the present invention presents the use of barbed wire to protect trees and plants.

### BRIEF DESCRIPTION OF THE DRAWINGS

In the accompanying drawings:

FIG. 1 shows a barbed wire wrapped over a tree to ward off wild animals;

### DETAILED DESCRIPTION OF THE INVENTION

The examples given in the following are for the purpose of illustration. The scope of the invention is not limited to the given examples in this disclosure.

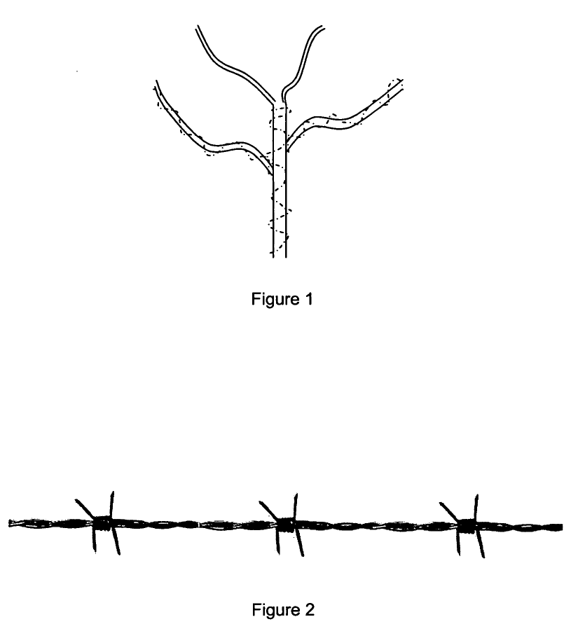

Reference is first made to FIG. 1 which shows the method of the present invention. It consists of sharp and physically agitating wire wrapped over plants and trees. Such a device could be built from any material that sustains a certain level of stiffness and has relatively sharp edges.

One common way to obtain such a device is to wind up two strands of metallic object with sharply cut pieces in specific intervals as shown in FIG. 1. Such devices like barbed wire could be purchased commercially in different lengths and thicknesses. It comes in reels that could be wound open and cut to the desired length.

It should be noted however that any type of material could be used according to the present invention so long as there are sharp edges provided in specific intervals. In addition, different thickness and sizes of the material could be used according to the application. Moreover, the material could be painted to match the color of the plant. Alternatively, when conformity is not an issue, the color could be used as an extra warning. For instance, bright colors or luminescent colors could be used as a warning against animals.

Other examples of the invention could be used as long as they use the same principles, namely, physical agitation of an animal by sharp objects trying to consume a plant. All such examples could be used without departing from the spirit of the present invention, the scope of which is determined by the following claims.

1. A method for protecting on of a tree and a plants against one of a consumption and damage by animals, said method comprising placing an object having sharp segments on one of the tree and the plants.

2. The method of claim 1, wherein said object comprise barbed wire.

3. The method of claim 1, wherein said object is painted to match the color of the tree.

4. The method of claim 1, wherein said object is painted in bright color to warn animals.

5. The use of an object having sharp segments to protect one of a tree and a plant against one of a consumption and damage by animals.

6. The use of barbed wire to protect one of a tree and a plant against one of a consumption and damage by animals.
